(19) United States
(12) Patent Application Publication
(10) Pub. No.: US 2024/0174492 A1
(43) Pub. Date: May 30, 2024

(54) BRACKET ASSEMBLY FOR LIFTING AN ARTICULATED MACHINE

(71) Applicant: VOLVO CONSTRUCTION EQUIPMENT AB, Eskilstuna (SE)

(72) Inventors: Dinesh Jegadesh, BANGALORE (IN); Maruthi B, BANGALORE (IN)

(21) Appl. No.: 18/519,517

(22) Filed: Nov. 27, 2023

(30) Foreign Application Priority Data
Nov. 29, 2022 (EP) 22210205.5

(51) Int. Cl. B66C 1/20

(52) U.S. Cl. CPC B66C 1/20; E01C 19/22

(57) ABSTRACT

A bracket assembly for lifting of an articulated machine at a centre point, the bracket assembly comprising: a first rigid bracket extending along a longitudinal axis and including proximal end portion for attaching the bracket assembly to the articulated machine and a distal end portion, and a slider bracket including a through-hole for engagement with a lifting hook, the slider bracket is attached to the first rigid bracket at the distal end with a sliding mechanism that is configured to allow for the slider bracket to slide with respect to the first rigid bracket along the longitudinal axis between a default position and a lifting position, wherein in the lifting position the slider bracket reaches further in a distal direction compared to in the default position.

### CROSS REFERENCE TO RELATED APPLICATIONS

This application claims priority to European Patent Application No. 22210205.5, filed on Nov. 29, 2022, the disclosure and content of which is incorporated by reference herein in its entirety.

### TECHNICAL FIELD

The disclosure relates generally to bracket assemblies. In particular aspects, the disclosure relates to a bracket assembly for lifting of an articulated machine. The disclosure can be applied in various vehicle applications and although the disclosure may be described with respect to a particular vehicle, the disclosure is not restricted to any particular vehicle.

### BACKGROUND

Articulated compactor machines need a lifting point for attaching a lifting hook and transit the machine on and off a trailer at a construction site. The lifting point should be at or near a center of the machine to avoid excessive tilting of the machine when is it lifted above ground.

However, for compactor machines, the requirement of a center lifting point cause compromise on various parameters, such as articulation gap, operator visibility, and operator platform space which may affect the comfort for the operator of the machine.

### SUMMARY

According to a first aspect of the disclosure, there is provided a bracket assembly for lifting of an articulated machine at a center point, the bracket assembly comprising: a first rigid bracket extending along a longitudinal axis and including proximal end portion for attaching the bracket assembly to the articulated machine and a distal end portion, and a slider bracket including a through-hole for engagement with a lifting hook, the slider bracket is attached to the first rigid bracket at the distal end with a sliding mechanism that is configured to allow for the slider bracket to slide with respect to the first rigid bracket along the longitudinal axis between a default position and a lifting position, wherein in the lifting position the slider bracket reaches further in a distal direction compared to in the default position.

The first aspect of the disclosure may seek to provide a more convenient lifting point for the articulated machine. A technical benefit may include smaller articulation gap, improved visibility for an operator, and more space for an operator station which thereby enables for further and/or more advanced control devices such as joysticks or similar.

The inventors realized that a sliding bracket allows for an efficient yet robust mechanism for extending the length of the bracket in preparation for a lifting operation where the articulated machine may be lifted from a trailer to the ground or vice versa. When the lifting operation is complete, the sliding bracket is moved back to its default position where it is shorter than in the lifting position, thereby leaving more of the operator's field of view free. Further, by enabling for shortening the bracket assembly after a lifting operation, the bracket can get out of the way for an operation station, thus enabling more freedom in designing and in the placement of the operation station.

In some examples, the first rigid bracket may comprise guide rails that guide the sliding motion of the slider bracket. A technical benefit may be that the sliding motion is better steered and therefore more reliable and reproducible.

In some examples, the bracket assembly may comprise two parallel guide rails to enclose a width of the slider bracket. This advantageously may provide an even more robust sliding mechanism.

In some examples the guide rails may be arranged at the side edges of the distal end portion of the first rigid bracket. Thus, the first rigid bracket is not wider than necessary thereby saving material and therefore cost and reducing the weight of the first rigid bracket.

In some examples, the bracket assembly may comprise at least one stopper plate arranged on the first rigid bracket to limit the motion of the slider bracket in the proximal direction in the default position. Hereby, the slider bracket is maintained in the default position without falling an excessive amount in the proximal direction towards the lifting point.

In some examples, the bracket assembly may comprise two stopper plates arranged oppositely inclined with respect to the longitudinal axis. A technical benefit is that the stopper plates form a pocket to more reliable support the slider bracket in its upright position.

In some examples, in the lifting position, the though-hole of the slider bracket may be fully exposed so that the lifting hook can engage with the hole of the slider bracket.

In some examples, the slider bracket may be rigid. This provides for a more robust and durable construction.

In some examples, the slider bracket may comprise a lifting handle attached to one planar side of the slider bracket. Hereby, a more user-friendly bracket assembly is achieved where the lifting handle may be user by an operator or user for manually lifting the slider bracket to the lifting position when engaging a lifting hook to the slider bracket.

In some examples, the first rigid bracket may comprise though-holes at the proximal end for attaching the first rigid bracket to a front end of the articulated machine with bolts. Hereby, a robust mechanical attachment of the bracket assembly to the articulated machine is enabled.

In some examples, the sliding mechanism may comprise a slot in the distal end of the first rigid bracket that extends along the longitudinal axis. The slot may provide for further improved guiding of the slider bracket.

In some examples, the bracket assembly may comprise a pin arranged through a though-hole of the slider bracket and through the slot of the first rigid bracket, and a back plate attached to the pin opposite from the first rigid bracket to slidably attach the slider bracket to the first rigid bracket. This provides for yet further improved guiding and a more robust and reliable sliding mechanism. It further provides for a mechanical stop for the slider bracket in the distal position when it has moved distally in relation to the first rigid bracket during lifting operation.

In some examples, the back plate may engage with stopper plates arranged on the first rigid bracket to limit the motion of the slider bracket in the proximal direction in the default position.

In some examples, the back plate may have proximally facing inclined surfaces that abut against a respective stopper plate in the default position of the slider bracket. The engagement between the inclined surfaces and the stopper plate stabilized an upright position of the back plate and therefore also of the slider bracket in the default position.

In some examples, the first rigid bracket may be planar.

In some examples, the slider bracket may be planar. For instance, the interface between the first rigid bracket and the slider bracket is between planar surfaces to provide for a simplified and smooth sliding mechanism.

In some examples, the bracket assembly may be attached to a front frame of an articulated machine. This typically increases the available space for an operation in the operator space, compared to having the attachment to a rear frame.

In some examples, the slider bracket is planar and rigid, wherein the first rigid bracket comprises two parallel guide rails to enclose a width of the slider bracket that guide the sliding motion of the slider bracket along the longitudinal axis, the guide rails are arranged at the side edge of the distal end portion of the first rigid bracket, wherein the sliding mechanism comprises a slot in the distal end of the first rigid bracket that extends along the longitudinal axis, and the slider bracket comprises a pin arranged through a though-hole of the slider bracket and through the slot of the first rigid bracket, and a back plate attached to the pin opposite from the first rigid bracket to slidably attach the slider bracket to the first rigid bracket in the slot, the bracket assembly further comprises two stopper plates arranged on the first rigid bracket wherein the back plate engages with the stopper plates arranged on the first rigid bracket to limit the motion of the slider bracket in the proximal direction in the default position, the stopper plates arranged oppositely inclined with respect to the longitudinal axis, wherein the guide rails and the stopper plates are arranged on opposite sides of the first rigid bracket, wherein the back plate has proximally facing inclined surfaces that abut against a respective stopper plate in the default position of the slider bracket.

There is further provided in a second aspect of the disclosure, a vehicle comprising a bracket assembly.

In some examples, the vehicle may be an articulated compactor machine.

The above aspects, accompanying claims, and/or examples disclosed herein above and later below may be suitably combined with each other as would be apparent to anyone of ordinary skill in the art.

Additional features and advantages are disclosed in the following description, claims, and drawings, and in part will be readily apparent therefrom to those skilled in the art or recognized by practicing the disclosure as described herein. There are also disclosed herein control units, computer readable media, and computer program products associated with the above discussed technical benefits.

### BRIEF DESCRIPTION OF THE DRAWINGS

With reference to the appended drawings, below follows a more detailed description of aspects of the disclosure cited as examples.

FIG. 1A is a perspective view of an exemplary bracket assembly according to one example.

FIG. 1B is a perspective view of an exemplary bracket assembly according to one example.

FIG. 2 is a perspective view of a first rigid bracket according to one example.

FIG. 3 is an exploded view of a bracket assembly according to one example.

FIG. 4A is a perspective view of an exemplary bracket assembly with the slider bracket in a default position according to one example.

FIG. 4B is a perspective view of an exemplary bracket assembly with the slider bracket in a lifting position according to one example.

FIG. 5A is a cross-sectional view of an exemplary bracket assembly with the slider bracket in a default position according to one example.

FIG. 5B is a cross-sectional view of an exemplary bracket assembly with the slider bracket in a lifting position according to one example.

FIG. 6A is an articulated machine having a bracket assembly with the slider bracket in a default position according to one example.

FIG. 6B is an articulated machine having a bracket assembly with the slider bracket in a lifting position according to one example.

### DETAILED DESCRIPTION

Aspects set forth below represent the necessary information to enable those skilled in the art to practice the disclosure.

Articulated machines such as compactors may be transported on a trailer to a construction site and are typically very heavy. Lifting such a heavy machine off the trailer requires a strong lifting arrangement that can carry the heavy machine. However, at the same time, the articulated machine must be kept substantially horizontal during the lifting operation which sets constraints on where the lifting point can be. These constraints have shown to lead to other issues in prior art lifting arrangements, such as poor visibility for an operator, wide articulation gaps, and reduced space for operation control stations. At least some these drawbacks are addressed by examples of the present disclosure.

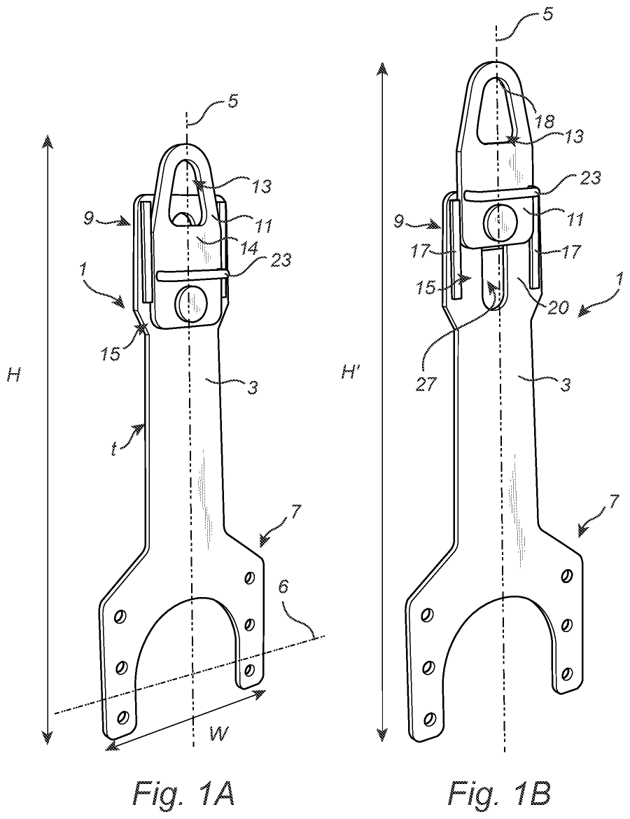

FIG. 1A is an exemplary bracket assembly 1 according to one example. The bracket assembly 1 is configured for lifting an articulated machine at a center point.

The bracket assembly 1 comprises a first rigid bracket 3 extending along a longitudinal axis 5. The first rigid bracket 3 includes proximal end portion 7 for attaching the bracket assembly 1 to the articulated machine. The first rigid bracket 3 further includes a distal end portion 9 on the opposite end of the first rigid bracket 3 with respect to the proximal end 7. The longitudinal axis 5 intersect the proximal end 7 and the distal end portion 9.

The bracket assembly 1 has a height H along the longitudinal axis 5, and a width W in the transverse direction 6 perpendicular to the longitudinal axis 5. The height H and width W are substantially larger than the thickness t of the first rigid bracket 3.

The bracket assembly 1 further comprises a slider bracket 11 that has a through-hole 13 for engagement with a lifting hook for lifting the articulate machine. The slider bracket 11 is attached to the first rigid bracket 3 at the distal end 9 with a sliding mechanism 15 that is configured to allow for the slider bracket 11 to slide with respect to the first rigid bracket 3 along the longitudinal axis 5 between a default position, shown in FIG. 1A and a lifting position shown in FIG. 1B, wherein in the lifting position the slider bracket 11 reaches further in a distal direction, i.e., along the axis 5 in a direction pointing from the proximal end 7 to the distal end 9, compared to in the default position.

More specifically, in the default position, the height of the bracket assembly is H, whereas in the lifting position shown in FIG. 1B, the height is H′, where H′ is larger than H. The height H′ of the bracket assembly 1 in the lifting position may be about 10%, or 20%, or 30%, or 40% larger than the height H of the bracket assembly 1 in the default position.

A typical thickness t is about 3-25 mm, such as 5 mm, 10 mm, 15 mm or 20 mm typical height H is about 600-1100 mm, such as 700 mm, 800 mm, 850 mm, 950 mm, where in one specific example the height H is 850 mm. A typical width W is about 200-450 mm, such as 250 mm, 300 mm 310 mm, 320 mm, 350 mm, or, 400, where in one specific example the width W is 310 mm. The height H′ may be about 70-150 mm larger than the height H, such as 80 mm, 90 mm, 100, mm, 120 mm, or 130 mm larger, and in one specific example H′ is 100 mm larger than H. The total thickness of the bracket including the handle 23 may be about 80-120 mm, and in one specific example the total thickness is about 100 mm.

The sliding mechanism 15 advantageously allows for the sliding bracket 11 to move freely if the slider bracket 11 is manually moved in the distal direction, e.g., by hand using the handle 23 attached to the slider bracket 11, in one example attached on a planar side of the slider bracket 11. Further, if the bracket assembly 1 is oriented with the longitudinally axis substantially vertical with the distal end 9 pointing upwards, the slider bracket 11 will fall from the lifting position back to the default position only due to gravity.

The through-hole 13 penetrates from one side or face 14 to the opposite side or face of the slider bracket 11. The through-hole 13 includes a proximally facing surface 18 that engages with a lifting hook during a lifting operation. Further, the slider bracket 11 is advantageously rigid to allow for heavy lifting operations. A rigid bracket is here interpreted as a bracket that does not deform unless excessive force is applied to it, and it should be able to withstand multiple lifting operations.

The first rigid bracket and the slider bracket may for example be made from a steel or another rigid and strong metal-based material.

The first rigid bracket 3 is planar, at least on the distal end where the sliding mechanism 15 is located. This enables an efficient sliding mechanism 15 where the planar surface 20 of the first rigid bracket 3 provides a sliding surface for a corresponding planar surface of the planar slider bracket 11, that jointly form a sliding interface between the first rigid bracket 3 and the slider bracket 11.

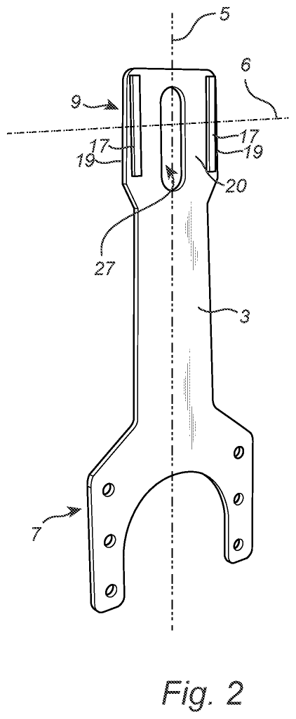

FIG. 2 is a perspective view of the first rigid bracket 3. To improve the directionality and stability of the sliding motion of the slider bracket 11, the first rigid bracket 3 comprises guide rails 17 that guide the sliding motion of the slider bracket 11. The guide rails 17 are elongated and extend substantially in parallel with the longitudinal axis 5. Further, the guide rails 17 are parallel to each other and are arranged separated a distance from each other along a transverse axis 6 of the first bracket. The transverse axis 6 is perpendicular to the longitudinal axis 5. The distance between the parallel guide rails 17 is slightly larger than a width of the slider bracket 11 so that the slider bracket can slide between the guide rails 17 with some tolerance. Thus, the two parallel guide rails 17 enclose a width of the slider bracket 11.

To save material cost and reduce the weight of first rigid bracket 3, the distal end portion 9 of the first rigid slider bracket 11 is only sufficiently wide to arrange the guide rails at the side edges 19 of the distal end portion 9. In other words, the guiding rails 17 may be attached, e.g., by welding, as close as possible to the side edges 19 defining the width of the distal end portion 9 of the first rigid bracket 3.

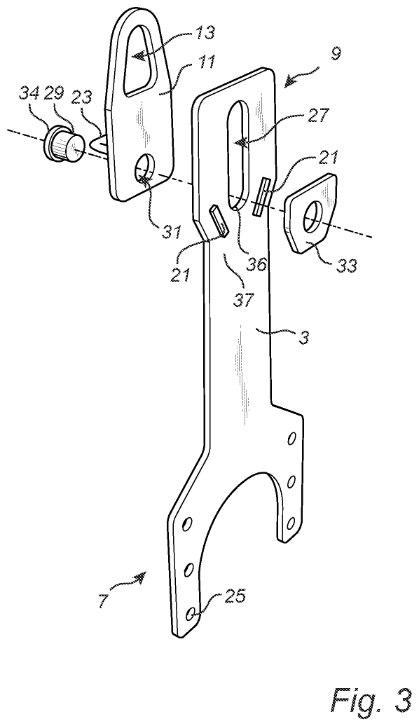

FIG. 3 is an exploded view of the example bracket assembly 1. The view in FIG. 3 is the opposite side of the view in FIGS. 1A-B. FIG. 3 shows stopper plates 21, back plate 33, and a pin 29 which both are rigid and may be made from steel. The cylindrical pin 29 is arranged through a through-hole 31 through the thickness of the slider bracket 11, through the slot 27 of the first rigid bracket 3 and attached to the back plate 33. The pin 29 comprises a flange 34 with a larger diameter than the diameter of the through-hole 31 of the slider bracket 11 so that the flange cannot penetrate through the through-hole 31. The slider bracket 11 and the distal end portion 9 of the first rigid bracket 3, with the slot 27, are sandwiched between the flange 34 and the back plate 33. The slot 27 in the distal end 9 of the first rigid bracket 3 extends along the longitudinal axis 5 and is part of the sliding mechanism 15.

The two stopper plates 21 are arranged inclined with respect to the longitudinal axis 5 such as to form a V-shape with the opening facing in the distal direction 9. The stopper plates are arranged at the proximal end 36 of the slot 27 so that they limit the motion of the slider bracket 11 in the proximal direction in the default position. The stopper plates 21 may be welded to the planar surface 37 of the first rigid bracket.

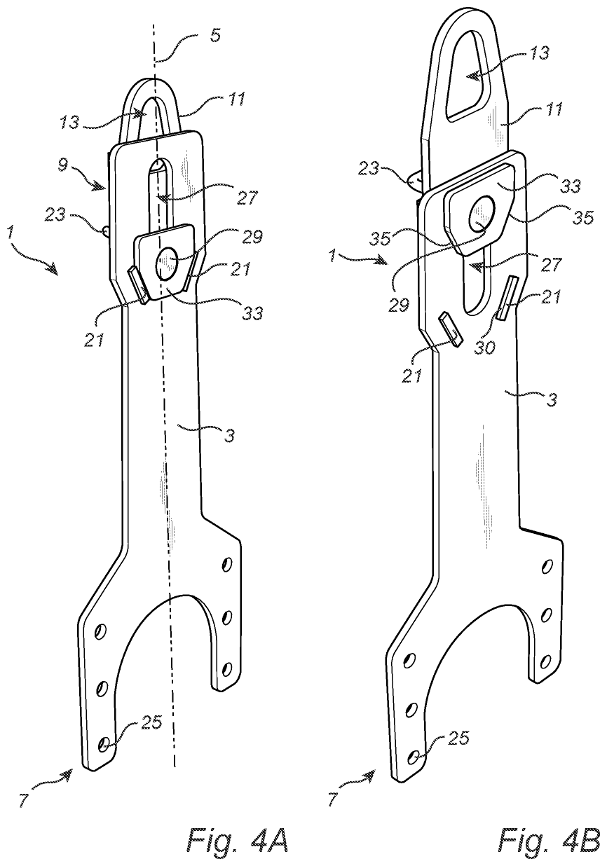

FIG. 4A shows another perspective view of the bracket assembly 1 in the default position and FIG. 4B shows another perspective view of the bracket assembly 1 in the lifting position.

In the default position, FIG. 4A the two inclined stopper plates 21, arranged symmetrically with respect to the longitudinal axis 5, form a pocket for catching the back plate 33 and maintain the slider bracket 11 in an upright orientation and prevent it from rotation about the axis of the pin 29. The two stopper plates 21 are arranged oppositely inclined with respect to the longitudinal axis 5. The back plate 33 thus engages with or abuts against the stopper plates 21 arranged on the first rigid bracket 3 to limit the motion of the slider bracket 11 in the proximal direction in the default position.

Furthermore, as better seen in FIG. 4B, the back plate 33 has proximally facing inclined surfaces 35 that abut against a distally facing surface 30 of a respective stopper plate 27 in the default position of the slider bracket. Thus, the shape of the back plate 33 on the side facing the stopper plates 27 is similar to or matches the inclination of the stopper plates 21 with respect to the longitudinal axis 5.

In the lifting position shown in FIG. 4B, the though-hole 13 of the slider bracket is fully exposed so that the lifting hook can engage with the hole of the slider bracket. In the default position, shown in FIG. 4A, part of the though-hole 13 is blocked by the first rigid bracket 3.

In addition, the first rigid bracket 3 comprises though-holes 25 at the proximal end 7 for attaching the first rigid bracket 3 to a front end of the articulated machine with bolts.

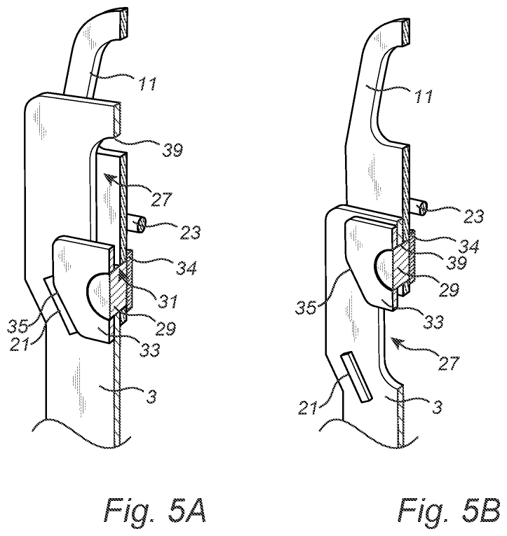

FIG. 5A shows a cross-section of the bracket assembly 1 in the default position and FIG. 5B shows a cross-section of the bracket assembly 1 in the lifting position.

The pin 29 is arranged through a though-hole 31 of the slider bracket 11 and through the slot 27 of the first rigid bracket, and a back plate 33 attached to the pin opposite from the first rigid bracket to slidably attach the slider bracket 11 to the first rigid bracket 3. The back plate 33 and the pin 29 may be joined by welding or by a press-fit or friction connection, or by a bolt and nut arrangement.

In the lifting position shown in FIG. 5B, the pin 29 abuts against a proximally facing surface 39 of the distal end of the slot 27, to stop the sliding motion of the slider bracket 11 so that a lifting operation can be performed.

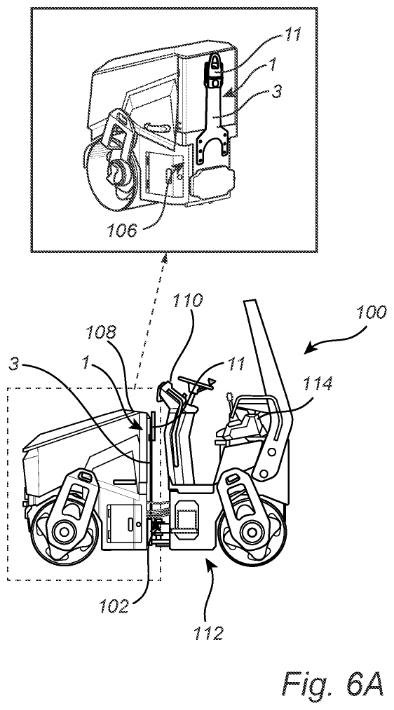

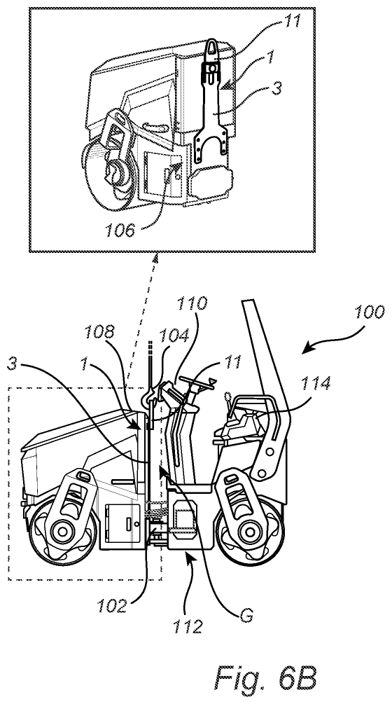

FIG. 6A illustrates an example vehicle in the form of an articulated machine 100 comprising a front frame 106. A bracket assembly 1 is attached via e.g., bolts or welding, to the front frame 106 at a center point 102, i.e., close to the articulated joint of the machine 100. The articulate machine is here exemplified as an articulated compactor machine configured to compress material such as soil or asphalt.

In FIG. 6A the bracket assembly 1 is in the default position. Here, the bracket assembly is well below the level of the front part 108 and well below the operation station 110 on the rear part 112 accommodating the operator seat 114. This means that the bracket assembly has no impact on the forward visibility for an operation located in the operator seat 114. When a lifting operation is carried out, now turning to FIG. 6B, a lifting hook 104 is engaged with the slider bracket 11, here in the lifting position, i.e., the slider bracket 11 has moved further distally compared to the default position FIG. 6A. The motion in the distal direction may be due to the lifting hook action or by manual motion of the slider bracket 11 to enable for the lifting hook to hook into the through-hole 13 of the slider bracket 11.

Furthermore, the flatness of the bracket assembly, that is, the slider bracket and the first rigid bracket are planar with a thickness t much smaller than the width W and the height H, the articulation gap between the front frame 106 and the rear part can be reduced. With the bracket assembly 1 being extendable between lifting and default positions, it can be well integrated in the articulation gap G without obstructing the field of view of the operator and the available space for an operator station 110. Thus, the bracket assembly provides for more space for the operator station arranged as a center console with items such as joy sticks, displays, jog shuffle and keypad and other potential control devices.

In one single example, the slider bracket is planar and rigid, the first rigid bracket comprises two parallel guide rails to enclose a width of the slider bracket that guide the sliding motion of the slider bracket along the longitudinal axis, the guide rails are arranged at the side edge of the distal end portion of the first rigid bracket, the sliding mechanism comprises a slot in the distal end of the first rigid bracket that extends along the longitudinal axis, and the slider bracket comprises a pin arranged through a though-hole of the slider bracket and through the slot of the first rigid bracket, and a back plate attached to the pin opposite from the first rigid bracket to slidably attach the slider bracket to the first rigid bracket in the slot, the bracket assembly further comprises two stopper plates arranged on the first rigid bracket wherein the back plate engages with the stopper plates arranged on the first rigid bracket to limit the motion of the slider bracket in the proximal direction in the default position, the stopper plates arranged oppositely inclined with respect to the longitudinal axis, wherein the guide rails and the stopper plates are arranged on opposite sides of the first rigid bracket, wherein the back plate has proximally facing inclined surfaces that abut against a respective stopper plate in the default position of the slider bracket.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the inventive concepts being set forth in the following claims.

What is claimed is:

1. A bracket assembly for lifting of an articulated machine at a centre point, the bracket assembly comprising:
a first rigid bracket extending along a longitudinal axis and including proximal end portion for attaching the bracket assembly to the articulated machine and a distal end portion, and
a slider bracket including a through-hole for engagement with a lifting hook, the slider bracket is attached to the first rigid bracket at the distal end with a sliding mechanism that is configured to allow for the slider bracket to slide with respect to the first rigid bracket along the longitudinal axis between a default position and a lifting position, wherein in the lifting position the slider bracket reaches further in a distal direction compared to in the default position.

2. The bracket assembly of claim 1, wherein the first rigid bracket comprises guide rails that guide the sliding motion of the slider bracket.

3. The bracket assembly of claim 2, comprising two parallel guide rails to enclose a width of the slider bracket.

4. The bracket assembly of claim 3, wherein the guide rails are arranged at the side edges of the distal end portion of the first rigid bracket.

5. The bracket assembly of claim 1, comprising at least one stopper plate arranged on the first rigid bracket to limit the motion of the slider bracket in the proximal direction in the default position.

6. The bracket assembly of claim 5, comprising two stopper plates arranged oppositely inclined with respect to the longitudinal axis.

7. The bracket assembly of claim 1, wherein in the lifting position though-hole of the slider bracket is fully exposed so that the lifting hook can engage with the hole of the slider bracket.

8. The bracket assembly of claim 1, wherein the slider bracket comprises a lifting handle attached to one planar side of the slider bracket.

9. The bracket assembly of claim 1, wherein the sliding mechanism comprises a slot in the distal end of the first rigid bracket that extends along the longitudinal axis.

10. The bracket assembly of claim 1, comprising a pin arranged through a though-hole of the slider bracket and through the slot of the first rigid bracket, and a back plate attached to the pin opposite from the first rigid bracket to slidably attach the slider bracket to the first rigid bracket.

11. The bracket assembly of claim 10, wherein the back plate engages with stopper plates arranged on the first rigid bracket to limit the motion of the slider bracket in the proximal direction in the default position.

12. The bracket assembly of claim 11, wherein the back plate has proximally facing inclined surfaces that abut against a respective stopper plate in the default position of the slider bracket.

13. The bracket assembly of claim 1,
wherein the slider bracket is planar and rigid,
wherein the first rigid bracket comprises two parallel guide rails to enclose a width of the slider bracket that guide the sliding motion of the slider bracket along the longitudinal axis, the guide rails are arranged at the side edge of the distal end portion of the first rigid bracket,
wherein the sliding mechanism comprises a slot in the distal end of the first rigid bracket that extends along the longitudinal axis, and the slider bracket comprises a pin arranged through a though-hole of the slider bracket and through the slot of the first rigid bracket, and a back plate attached to the pin opposite from the first rigid bracket to slidably attach the slider bracket to the first rigid bracket in the slot,
the bracket assembly further comprises two stopper plates arranged on the first rigid bracket wherein the back plate engages with the stopper plates arranged on the first rigid bracket to limit the motion of the slider bracket in the proximal direction in the default position,
the stopper plates arranged oppositely inclined with respect to the longitudinal axis, wherein the guide rails and the stopper plates are arranged on opposite sides of the first rigid bracket, wherein the back plate has proximally facing inclined surfaces that abut against a respective stopper plate in the default position of the slider bracket.

14. A vehicle comprising bracket assembly according to claim 1.

15. The vehicle of claim 14, wherein the vehicle is an articulated compactor machine.
